(19) United States
(12) Patent Application Publication
(10) Pub. No.: US 2017/0004152 A1
(43) Pub. Date: Jan. 5, 2017

(54) SYSTEM AND METHOD FOR DYNAMIC DATA ARCHIVAL AND PURGING

(71) Applicant: BANK OF AMERICA CORPORATION, Charlotte, NC (US)

(72) Inventors: Venkata Ramana Rao Kommisetty, Hyderabad (IN); Amit Rathaur, Mumbai (IN); Calderwood D. Speer, Fort Worth, TX (US)

(21) Appl. No.: 14/788,467

(22) Filed: Jun. 30, 2015

(51) Int. Cl. G06F 17/30

(52) U.S. Cl. CPC G06F 17/30309; G06F 17/30569

(57) ABSTRACT

An interface receives a user request associated with a first set of data. A processor determines whether the user request comprises a request to archive the first set of data. Upon a determination that the user request comprises a request to archive the first set of data, the processor facilitates retrieving archive rules, applies the archives rules to determines a first archive code for execution, and archives the first set of data based on the first archive code.

### TECHNICAL FIELD

This invention relates generally to data, and more particularly to archiving and purging data.

### BACKGROUND

Enterprises may receive and store many sets of data. Over time, the amount of data stored on a system may become too large and cumbersome for the system. To alleviate this problem, data may be archived or purged. In conventional systems, each piece of data must be deleted or archived manually.

### SUMMARY OF EXAMPLE EMBODIMENTS

According to embodiments of the present disclosure, disadvantages and problems associated with archiving and purging data may be reduced or eliminated.

In accordance with a particular embodiment of the present disclosure, an interface receives a user request associated with a first set of data. A processor determines whether the user request comprises a request to archive the first set of data. Upon a determination that the user request comprises a request to archive the first set of data, the processor facilitates retrieving archive rules, applies the archives rules to determine a first archive code for execution, and archives the first set of data based on the first archive code.

In accordance with another embodiment of the present disclosure, a method for communicating reports to external modules includes receiving a user request associated with a first set of data and, upon a determination that the user request comprises a request to archive the first set of data: retrieving archive rules; applying the archive rules to determine a first archive code for execution; and archiving the first set of data based on the first archive code.

Certain embodiments of the present disclosure may provide one or more technical advantages. A technical advantage of one embodiment includes reducing the time required to archive and purge data, which improves efficiency of computer resources that handle large amounts of data. As another example, a technical advantage of one embodiment includes uniformly applying rules to archive and purge data. As yet another example, the system and method described herein is project independent. Therefore, the system may archive and purge different sets and types of data.

Other technical advantages of the present disclosure will be readily apparent to one skilled in the art from the following figures, descriptions, and claims. Moreover, while examples of specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates a system for archiving and purging data;

FIG. 2 illustrates an example graphical user interface that facilitates the use of a system for archiving and purging data; and

FIG. 3 illustrates an example method for archiving and purging data.

### DETAILED DESCRIPTION

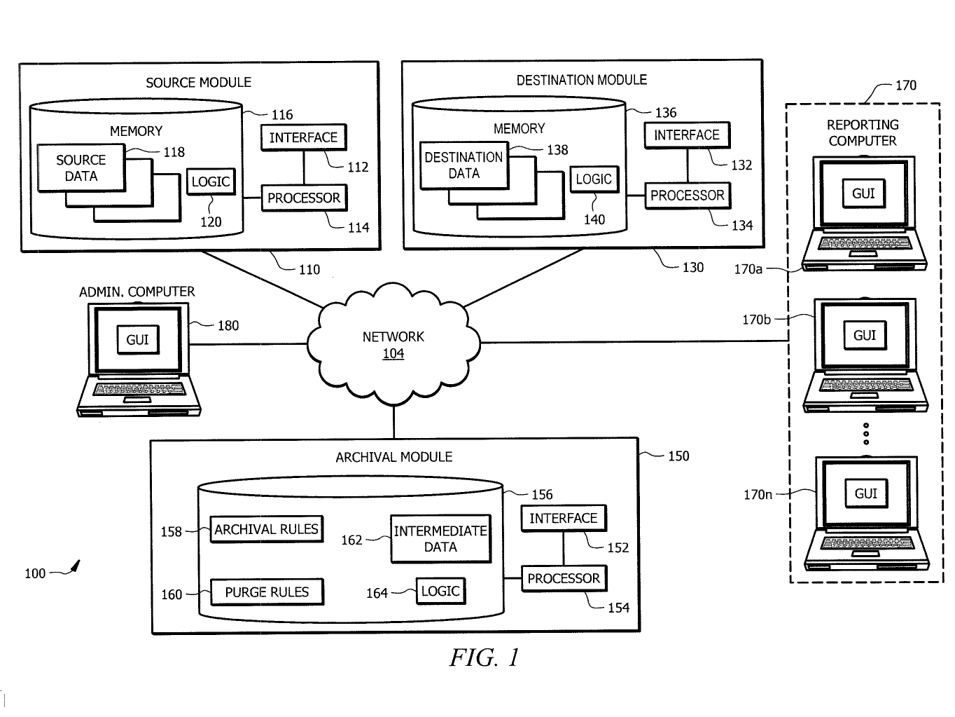

Embodiments of the present invention and its advantages are best understood by referring to FIGS. 1, 2, and 3, like numerals being used for like and corresponding parts of the various drawings.

Enterprises store various types of data. Over time, the amount of data stored may become too large for a particular storage device. Further, older data sets may need to be transferred to another location. In some instances, older data sets are no longer needed and may be deleted to free up space on a storage device. For example, a call center may log data related to received calls and store the data on a local server. Over time, the data may reach the memory capacity of the local server. In an embodiment of the current disclosure, a user may utilize an archival module to archive the data by moving the data to a different server. In another embodiment, a user may utilize the archival module to purge data from the local server. By using the archival module, a user may save time in archiving or purging mass amounts of data. Further, in an embodiment where the data is archived, all data may be archived in a uniform manner.

The teachings of this disclosure recognize that it would be desirable to provide a customized tool to uniformly apply rules to archive and purge data. The teachings of this disclosure also recognize that it would be desirable for the customized tool to dynamically archive or purge multiple sets of data. This leads to more accurate archiving by applying rules in a uniform manner. Additionally, the teachings of this disclosure provide for greater efficiencies in computer resources and network usage.

FIG. 1 illustrates a system for archiving and purging data. System 100 includes source module 110, destination module 130, archival module 150, administrative computer 180, and reporting computer 170 that may be communicatively coupled by network 104. Generally, archival module 150 archives data stored in source module 110 by removing data from source module 110 and storing the data in destination module 130 or copying data from source module 110 and storing a copy of the data in destination module 130. Archival module 150 may additionally purge data stored in source module 110 or destination module 130.

System 100 may include source module 110. Generally, source module 110 contains data that system 100 archives and/or purges. Source module 110 may include a network service, any suitable remote service, a mainframe, a host computer, a workstation, a web server, a personal computer, a file server, or any other suitable device operable to communicate with data sources 10, external modules 16, administrative computer 180, or any other suitable component of system 100 via network 104. In some embodiments, source module 110 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of source module 110 may be performed by any suitable combination of one or more servers or other components at one or more locations. In the embodiment where the modules are servers, the servers may be public or private servers, and each server may be a virtual or physical server. The server may include one or more servers at the same or at remote locations. Also, source module 110 may include any suitable component that functions as a server.

In the illustrated embodiment, source module 110 includes interface 112, processor 114, and memory 116. Interface 112 represents any suitable device operable to receive information from network 104, transmit information through network 104, perform suitable processing of the information, communicate to other devices, or any combination of the preceding. For example, interface 112 transmits data to archival module 150. As another example, interface 112 receives information from archival module 150. As a further example, interface 112 transmits data to destination module 130. In another example, interface 112 may communicate with administrative computer 180 and/or reporting computer 170. Interface 112 represents any port or connection, real or virtual, including any suitable hardware and/or software, including protocol conversion and data processing capabilities, to communicate through a LAN, WAN, or other communication systems that allows source module 110 to exchange information with archival module 150, destination module 130, administrative computer 180, reporting computer 170, and/or other components of system 100 via network 104.

Processor 114 controls the operation and administration of source module 110 by processing information received from interface 112 and memory 116. Processor 114 communicatively couples to interface 112 and memory 116. Processor 114 includes any hardware and/or software that operates to control and process information. For example, processor 114 may be a programmable logic device, a microcontroller, a microprocessor, any suitable processing device, or any suitable combination of the preceding.

Memory 116 may be a database that stores, either permanently or temporarily, source data 118, logic 120, any other suitable data, or any combination of the preceding. Memory 116 includes any one or a combination of volatile or non-volatile local or remote devices suitable for storing information. For example, memory 116 may include Random Access Memory (“RAM”), Read-only Memory (“ROM”), magnetic storage devices, optical storage devices, or any other suitable information storage device or combination of these devices. Memory 116 may include any suitable information for use in the operation of source module 110. Additionally, memory 116 may be a component external to source module 110. Memory 116 may be located in source module 110, archival module 150, or any other location suitable for memory 116 to communicate with source module 110.

Memory 116 may include source data 118. Source data 118 represents any information that may be stored in source module 110 or any other suitable component of system 100. Source module 110 may receive source data 118 from a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of an entity and who provides such knowledge for communication to source module 110), one or more documents (such as a spreadsheet that contains data), the Internet (which may include articles and other information containing data), an open source intelligence report, a media outlet such as a television station or a radio station that broadcasts information that may be communicated to source module 110), any other suitable source of information, or any combination of the proceeding. In an embodiment, source data 118 may pertain to call information. For example, a call center employee may receive a call from a customer. The employee may input information related to the call into a graphical user interface, dashboard, or other suitable component for receiving information. For example, the employee may specify the length of the call, the purpose of the call, information identifying the caller, whether an issue was resolved, or any other suitable information related to the call. This data may then be stored as source data 118 in source module 110. In an embodiment, source data 118 may comprise tables of data. Source data 118 may also contain metadata. The metadata may comprise characteristics about the source data 118. Although source data 118 is illustrated as being located in memory 116, source data 118 may be located in memory 136, memory 156, or any other suitable component of system 100. Further, source data 118 may be located in multiple locations. For example, in the embodiment where there are multiple source modules 110, source data 118 may be located in one or more of the source modules 110, each source module 110 containing the same or different source data 118.

Memory 116 may further include logic 120. Logic 120 generally refers to logic, rules, algorithms, codes, tables, and/or other suitable instructions embodied in a computer-readable storage medium for operation of source module 110. For example, in a response to a request from archival module 150, administrative computer 180, reporting computer 170, and/or destination module 130, logic 120 may facilitate archiving and/or purging source data 118. In another embodiment, logic 120 may facilitate communicating source data 118 to archival module 150, destination module 130, and/or any other suitable component of system 100. In a further embodiment, logic 120 may facilitate receiving data from source module 110 and storing the data in memory 116 as source data 118.

Network 104 facilitates communications between source module 110, destination module 130, administrative computer 180, archival module 150, reporting computer 170, and any other suitable component of system 100. This disclosure contemplates any suitable network 104 operable to facilitate communication between the components of system 100. Network 104 may include any interconnecting system capable of transmitting audio, video, signals, data, messages, or any combination of the preceding. Network 104 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100. This disclosure contemplates end networks having one or more of the described properties of network 104.

System 100 may also include destination module 130. Generally, destination module 130 stores archived data. For example, destination module 130 may receive source data 118 and archive the data as destination data 138. Destination module 130 may include a network service, any suitable remote service, a mainframe, a host computer, a workstation, a web server, a personal computer, a file server, or any other suitable device operable to communicate with source module 110, archival module 150, administrative computer 180, or any other suitable component of system 100 via network 104. In some embodiments, destination module 130 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of destination module 130 may be performed by any suitable combination of one or more servers or other components at one or more locations. In the embodiment where the modules are servers, the servers may be public or private servers, and each server may be a virtual or physical server. The server may include one or more servers at the same or at remote locations. Also, destination module 130 may include any suitable component that functions as a server.

In the illustrated embodiment, destination module 130 includes interface 132, processor 134, and memory 136. Interface 132 represents any suitable device operable to receive information from network 104, transmit information through network 104, perform suitable processing of the information, communicate to other devices, or any combination of the preceding. For example, interface 132 transmits data to archival module 150. As another example, interface 132 receives information from archival module 150. As a further example, interface 132 receives data from source module 110. In another example, interface 132 may communicate with administrative computer 180 and/or reporting computer 170. Interface 132 represents any port or connection, real or virtual, including any suitable hardware and/or software, including protocol conversion and data processing capabilities, to communicate through a LAN, WAN, or other communication systems that allows destination module 130 to exchange information with archival module 150, source module 110, administrative computer 180, reporting computer 170, and/or other components of system 100 via network 104.

Processor 134 controls the operation and administration of destination module 130 by processing information received from interface 132 and memory 136. Processor 134 communicatively couples to interface 132 and memory 136. Processor 134 includes any hardware and/or software that operates to control and process information. For example, processor 134 may be a programmable logic device, a microcontroller, a microprocessor, any suitable processing device, or any suitable combination of the preceding.

Memory 136 may be a database that stores, either permanently or temporarily, destination data 138, logic 140, any other suitable data, or any combination of the preceding. Memory 136 includes any one or a combination of volatile or non-volatile local or remote devices suitable for storing information. For example, memory 136 may include RAM, ROM, magnetic storage devices, optical storage devices, or any other suitable information storage device or combination of these devices. Memory 136 may include any suitable information for use in the operation of destination module 130. Additionally, memory 136 may be a component external to destination module 130. Memory 136 may be located in destination module 130, archival module 150, or any other location suitable for memory 136 to communicate with destination module 130.

Memory 136 may include destination data 138. Destination data 138 represents any information that may be stored in destination module 130. Generally destination data 138 is archived data. For example, destination data 138 may be received from source module 110 and/or archival module 150 for archival. In an embodiment, destination data 138 may pertain to call information. For example, a user may utilize reporting computer 170 to instruct archival module 150 to remove or copy data from source module 110 or archival module 150 and store the data as destination data 138 in destination module 130. Destination data 138 may comprise tables of data. Destination data 138 may also contain metadata. The metadata may comprise characteristics about destination data 138. Destination module 130 may then archive the data as destination data 138. Although destination data 138 is illustrated as being located in memory 136, destination data 138 may be located in memory 116, memory 156, or any other suitable component of system 100. Further, destination data 138 may be located in multiple locations. For example, in the embodiment where there are multiple destination modules 130, destination data 138 may be located in one or more destination modules 130, each destination module 130 containing the same or different destination data 138.

Memory 136 may further include logic 140. Logic 140 generally refers to logic, rules, algorithms, codes, tables, and/or other suitable instructions embodied in a computer-readable storage medium for operation of destination module 130. For example, in response to a request from archival module 150, administrative computer 180, reporting computer 170, and/or destination module 130, logic 140 may facilitate archiving and/or purging destination data 138. In another embodiment, logic 140 may facilitate receiving source data 118 from archival module 150, source module 110, or any other suitable component of system 100.

System 100 may include archival module 150. Generally, archival module 150 applies rules to generate instructions to archive and/or purge data in source module 110, destination module 130, and/or any other suitable component of system 100. Archival module 150 may include a network service, any suitable remote service, a mainframe, a host computer, a workstation, a web server, a personal computer, a file server, or any other suitable device operable to communicate with source module 110, destination module 130, reporting computer 170, administrative computer 180, or any other suitable component of system 100 via network 104. In some embodiments, archival module 150 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of archival module 150 may be performed by any suitable combination of one or more servers or other components at one or more locations. In the embodiment where the modules are servers, the servers may be public or private servers, and each server may be a virtual or physical server. The server may include one or more servers at the same or at remote locations. Also, archival module 150 may include any suitable component that functions as a server.

In the illustrated embodiment, archival module 150 includes interface 152, processor 154, and memory 156. Interface 152 represents any suitable device operable to receive information from network 104, transmit information through network 104, perform suitable processing of the information, communicate to other devices, or any combination of the preceding. For example, interface 152 transmits instructions to source module 110 and/or destination module 130. As another example, interface 152 receives information from administrative computer 180, reporting computer 170, destination module 130, source module 110, and/or any other suitable component of system 100. As a further example, interface 152 receives data from source module 110 and transmits data to destination module 130. Interface 152 represents any port or connection, real or virtual, including any suitable hardware and/or software, including protocol conversion and data processing capabilities, to communicate through a LAN, WAN, or other communication systems that allows archival module 150 to exchange information with source module 110, destination module 130, administrative computer 180, reporting computer 170, and other components of system 100 via network 104.

Processor 154 controls the operation and administration of archival module 150 by processing information received from interface 152 and memory 156. Processor 154 communicatively couples to interface 152 and memory 156. Processor 154 includes any hardware and/or software that operates to control and process information. For example, processor 154 may be a programmable logic device, a microcontroller, a microprocessor, any suitable processing device, or any suitable combination of the preceding.

Memory 156 may be a database that stores, either permanently or temporarily, archival rules 158, purge rules 160, intermediate data 162, logic 164, any other suitable data, or any combination of the preceding. Memory 156 includes any one or a combination of volatile or non-volatile local or remote devices suitable for storing information. For example, memory 156 may include RAM, ROM, magnetic storage devices, optical storage devices, or any other suitable information storage device or combination of these devices. Memory 156 may include any suitable information for use in the operation of archival module 150. Additionally, memory 156 may be a component external to archival module 150. Memory 156 may be located in archival module 150, or any other location suitable for memory 156 to communicate with archival module 150.

Memory 156 may include archival rules 158. Archival rules 158 generally refer to logic, rules, algorithms, code, tables, and/or other suitable instructions embodied in a computer-readable storage medium for performing the described functions and operations of archival module 150. For example, archival rules 158 facilitate generating instructions to source module 110 to archive one or more source data 118. For example, archival rules 158 facilitate identifying and locating one or more source data 118 by metadata. Archival rules 158 may then facilitate generating instructions to communicate source data 118 to destination module 130 and/or archival module 150 for archival. Archival rules 158 may also generate code to provide instructions to destination module 130 to archive data. While illustrated as including particular information, archival rules 158 may include any suitable information for use in the operation of reporting module 150.

Memory 156 may include purge rules 160. Purge rules 160 generally refer to logic, rules, algorithms, code, tables, and/or other suitable instructions embodied in a computer-readable storage medium for performing the described functions and operations of archival module 150. For example, purge rules 160 facilitate generating instructions to source module 110 to purge one or more source data 118. For example, purge rules 160 facilitate identifying and locating one or more source data 118 by metadata and instructing source module 110 to purge source data 118. Archival rules 158 may also generate code to provide instructions to destination module 130 to purge data. While illustrated as including a particular module, archival rules 158 may include any suitable information for use in the operation of reporting module 150.

Memory 156 may also include intermediate data 162. In some embodiments, archival module 150 may retrieve data from source module 110 or destination module 130. Archival module may apply archive rules 158 or purge rules 160 to facilitate archiving or purging intermediate data 162. In an embodiment, archival module 150 may retrieve source data 118 from source module 110 via network 104 for archival. In some embodiments, destination module 130 may accept data in a certain format that is a different format than source data 118. Archival module 150 may transform source data 118 into a different format and store it as intermediate data 162 before communicating the data to destination module 130. In an embodiment, archival module 150 may only archive certain retrieved source data 118. Archival module 150 may store the source data 118 to be archived as intermediate data 162 before communicating the data to destination module 130.

Memory 156 may further include logic 164. Logic 164 generally refers to logic, rules, algorithms, codes, tables, and/or other suitable instructions embodied in a computer-readable storage medium for operation of archival module 150. For example, in a response to a request from administrative computer 180, reporting computer 170, or any other suitable component of system 100, logic 164 may facilitate archiving and/or purging source data 110, intermediate data 162, and/or destination data 138.

In the illustrated embodiment, system 100 further includes reporting computer 170. Reporting computer 170 may be a single computer or any suitable number of computers. Reporting computer 170 may be any device that interacts with system 100. For example, reporting computer 170 may interact with archival module 150 via network 104 to archive and/or purge source data 118, intermediate data 162, destination data 138, and/or any other suitable data within system 100. In another example, users may utilize reporting computers 170 to provide instructions to archival module 150 to apply archival rules 158 or purge rules 160. Reporting computers 170 may use a processor and a memory to execute and to perform any of the functions described herein. Reporting computer 170 may be a personal computer, a workstation, a laptop, a wireless or cellular telephone, an electronic notebook, a personal digital assistant, a tablet, or any other device (wireless, wireline, or otherwise) capable of receiving, processing, storing, and/or communication information with other components of system 100, or any combination of the preceding. Reporting computer 170 may also include a graphical user interface, such as a display, a touchscreen, a microphone, keypad, or other appropriate terminal equipment usable by a user. In an embodiment, reporting computer 170 includes graphical user interface 200 described below.

In the illustrated embodiment, system 100 further includes administrative computer 180. Administrative computer 180 may be any device that interacts with system 100. For example, administrative computer 180 may interact with archival module 150 via network 104 to create or modify archival rules 158, purge rules 160, or any other suitable component of archival module 150 or component of system 100. In another example, administrative computer 180 may interact with source module 110 and/or destination module 130 via network 104 to facilitate archiving and/or purging data. Administrative computer 180 may use a processor and a memory to execute and to perform any of the functions described herein. Administrative computer 180 may be a personal computer, a workstation, a laptop, a wireless or cellular telephone, an electronic notebook, a personal digital assistant, a tablet, or any other device (wireless, wireline, or otherwise) capable of receiving, processing, storing, and/or communication information with other components of system 100, or any combination of the preceding. Administrative computer 180 may also include a graphical user interface, such as a display, a touchscreen, a microphone, keypad, or other appropriate terminal equipment usable by a user.

A component of system 100 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

To better understand the functions of system 100, examples of archiving and purging data will be used. However, it is understood that system 100 may be used in a variety of contexts and areas to help efficiently archive and purge data.

In one exemplary embodiment of operation, a user may input data that is stored in source module 110. For example, a call center employee may receive a call from a customer. The employee may input information about the call into a graphical user interface, dashboard, or other suitable component for receiving information. For example, the employee may specify the length of the call, the purpose of the call, information identifying the caller, whether an issue was resolved, or any other suitable information related to the call. This data may then be stored as source data 118 in source module 110. Source data 118 may also contain metadata. The metadata may comprise characteristics about the source data 118 such as the location of source data 118, the time of the call, the origin of the call, the employee who fielded the call, the department or division who fielded the call, or any other suitable data about source data 118.

In an embodiment, administrative computer 180 provides instruction to archival module 150. Generally, administrative computer 180 modifies or creates rules in archival module 150. For example, administrative computer 180 may modify or update archival rules 158, purge rules 160, or any other suitable component of archival module 150. In an exemplary embodiment, users may use reporting computers 170 to provide instructions to archival module 150 to archive or purge data. For example, users may utilize graphical user interface 200 to provide the instructions. The instructions may identify data according to metadata.

In certain embodiments, archival module 150 may receive the instructions from reporting module 170 via network 104 and apply archival rules 158 and/or purge rules 160 to generate code. In an embodiment, the archival module 150 may utilize archival rules 158 to generate code that instructs source module 110 to communicate source data 118 to destination module 130 for archival. For example, source data 118 may be identified and selected by associated metadata. Destination module 130 may then archive the data as destination data 138. In an embodiment, the code may instruct source module 110 to communicate source data 118 to archival module 150 via network 104. Archival module 150 may store the data as intermediate data 162. Archival module 150 may apply archival rules 158 to intermediate data 162 to transform source data 118 to a different format. The transformation may be necessary if destination module 130 accepts data in a format different than source data 118. Archival module 150 may then communicate intermediate data 162 to destination module 130 for archival. In an embodiment, destination module 130 may only archive a copy of source data 118 as destination data 138. In an embodiment, archival module 150 may instruct destination module 130 to archive data for a predetermined amount of time and purge the data at the predetermined amount of time.

In an embodiment, system 100 may work in a similar manner as described above to purge data. After receipt of instructions from reporting computer 170, archival module 150 may apply purge rules 160 to generate code to instruct source module 110 to purge one or more source data 118. The code may identify particular source data 118 by metadata. Source module 110 may purge the identified source data 118 or may communicate the source data 118 to archival module 150 for purging. In an embodiment where source module 118 communicates source data 118 to archival module 150, archival module 150 may store the source data 118 as intermediate data 162 and purge the data. Archival module 150 may function in a similar way as described above to purge destination data 136. In an embodiment, archival module 150 may instruct source module 110 and/or destination module 130 to purge data after a predetermined amount of time.

Modifications, additions, or omissions may be made to system 100 without departing from the scope of the invention. For example, system 100 may include any number of source modules 110, destination modules 130, archival modules 150, reporting computers 170, and/or administrative computers 180. Furthermore, the components of system 100 may be integrated or separated. For example, source module 110 and destination module 130 may be incorporated into a single component.

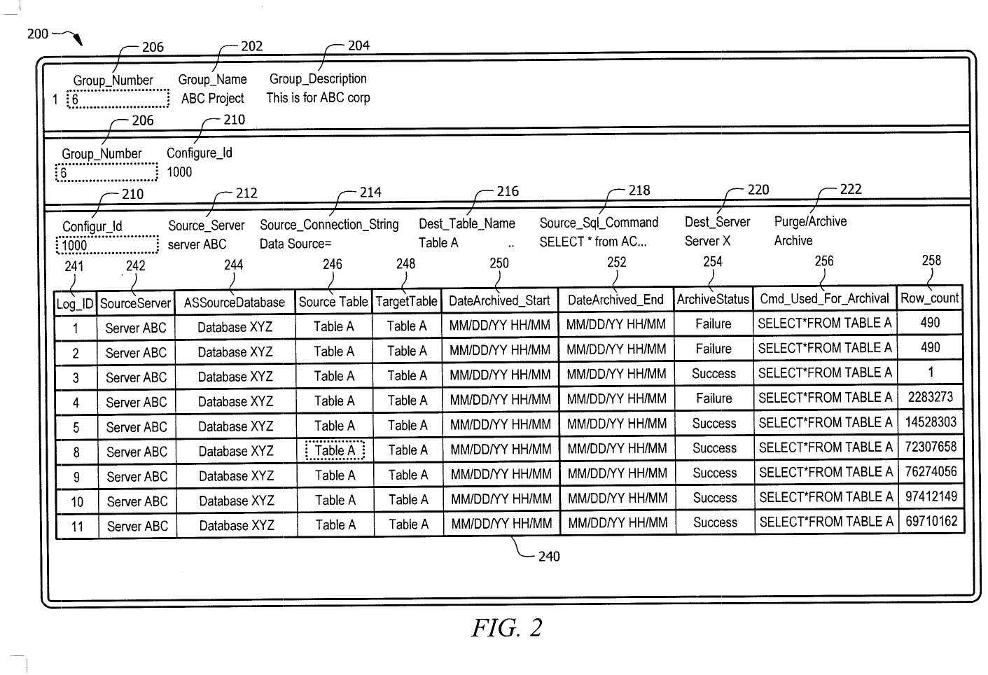

FIG. 2 illustrates an example graphical user interface that facilitates the use of system 100 for archiving and purging data. In an embodiment, graphical user interface 200 may be displayed on one or more reporting computers 170. Generally, a user inputs information in graphical user interface 200 to create user requests to communicate to archival module 150 to archive and/or purge data. In the illustrated embodiment, the first row of graphical user interface 200 comprises group name field 202, group description field 204, and group number field 206. Group name field 202 includes an identification of a particular project for system 100 to complete. For example, system 100 may have many source data 118 in multiple sources modules 110. Group name field 202 may identify a project to archive or purge certain source data 118. Group description field 204 may describe the project. For example, group description field 204 may identify that the group is associated with a particular entity, that the group contains a particular type of data, how often the group should be archived or purged, or any other suitable description. Group number field 206 is associated with group name field 202. For example, in the illustrated embodiment, group number field 206 includes “6,” which is a numerical representation of “ABC Project” shown in group name field 202.

The third row of the illustrated embodiment comprises configuration ID field 210, source server identification field 212, source connection string field 214, destination table name field 216, source SQL command field 218, destination server field 220, and purge/archive field 222. Source server identification field 212 identifies the location of the data to be purged or archive. For example, source server identification field 212 may identify a particular source module 110. As another example, source server identification field 212 may identify a particular destination module 130 or an archival module 150. Source connection string field 214 may identify a particular data source. For example, source connection string field 214 may identify source data 118, destination data 138, intermediate data 162, or any other suitable data in system 100. Destination table name field 216 specifies the location to archive data. For example, destination data 138 may comprise data tables. Destination table name field 216 may identify a table within destination data 138. For example, a user request may instruct system 100 to remove a table of data from source data 118 and archive the data within a table in destination data 138. The third row of graphical user interface 200 may include source SQL command field 218. Source SQL command field 218 may provide instructions for receiving data to be archived or purged. Destination server identification field 220 identifies the server where data is to be archived. For example, destination server identification field 220 may identify destination module 130. Purge/archive field 222 specifies whether the data is to be purged or archived. When the data is to be purged, not all of the fields in the third row may contain input. For example, when the data is to be purged, the destination fields in graphical user interface 200 may be blank. Configuration ID field 210 identifies the configuration settings in the third row of the table. In the illustrated embodiment, configuration ID field 210 identifies the fields selected in the third row of the table.

The second row of graphical user interface 200 contains group number field 206 and configuration ID field 210. This row may link group number field 206 with the configuration ID field 210. In an embodiment, the configuration identified of the third row of graphical user interface 200 may be applied to the group name identified in the first row of graphical user interface 200. A user may use graphical interface 200 to facilitate the operation of system 100 as described above. Some, none, or all of the fields may be completed. Further, graphical user interface may contain some, none, or all of the fields illustrated and discussed.

After graphical user interface 200 is used to archive and/or purge data as described above, reporting computer 170 or any other suitable component of system 100 may generate a log report 240. Generally, log report 240 provides information regarding a particular use of system 100. As illustrated, log report 240 may specify a source server 242, source database 244, a source table 246, a target table 248, start time 250, end time 252, status 254, command 256, and row count 258, and this information is identified by log ID 241. Source server 242 identifies the server where the archived or purged data was initially located before the operation of system 100. For example, source server 242 could be source module 100, archival module 150, destination module 130, or any other suitable component of system 100. Source database 244 may identify a certain dataset where the data to be archived is stored. For example, source database 244 may specify source data 118, intermediate data 162, destination data 138, or any other source dataset. Source table 246 may identify a table. For example, source data 118 may contain tables of data. Source table 246 could identify the table within the data that is archived or purged. Target table 248 indicates where archived data is stored. For example, when system 100 archives a table of data, the data may be archived in a table within destination data 138. Start time 250 and end time 252 illustrate when the archiving or purging request begins and when the task is complete, respectively. Archive status 254 indicates whether a particular request to archive or purge data was successful. Command 256 indicates the command used to archive or purge data. Row count 258 indicates the number of rows of a table that were archived or purged. Log 240 may comprise some, none, or all of these columns. Additionally, log 240 may contain additional columns to provide more, less, or different information regarding the execution of system 100 to archive or purge data.

Modifications, additions, or omissions may be made to graphical user interface 200 without departing from the scope of the invention. For example, a user may input some, none, or all of the fields in the first three rows of graphical user interface. In an embodiment, some fields may be generated automatically. As another example, log 240 may comprise additional or different information. Furthermore, graphical user interface 200 may be display on reporting computer 170, administrative computer 180, or any other suitable component of system 100.

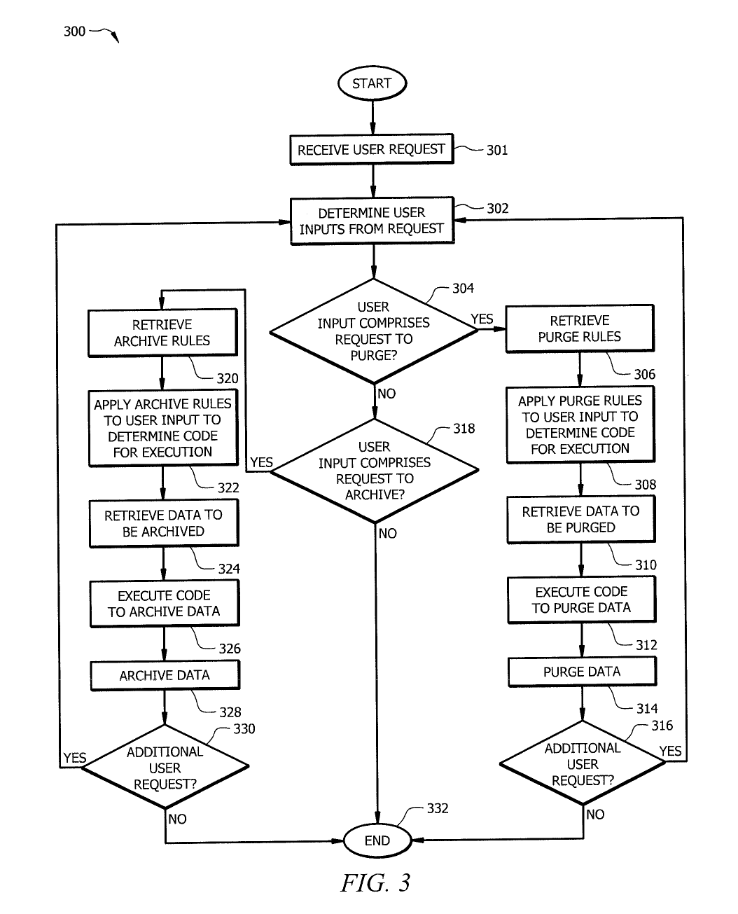

FIG. 3 illustrates an example method 300 for archiving and purging data. The method begins at step 301 where archival module 150 receives a user request. For example, the user request could be received from reporting computer 170. In an embodiment, a user may input information into a graphical user interface described in FIG. 2 to facilitate the user request. The method may then proceed to step 302 where archival module 150 determines user inputs from the user request. In an embodiment, archival module 150 may utilize logic 164 and processor 154 to determine user inputs from the user request. At step 304, archival module 150 determines whether the user input comprises a request to purge data. If archival module 150 determines that there is a request to purge data, the method proceeds to step 306. Otherwise, the method proceeds to step 318.

At step 306, archival module 150 receives purge rules 160. At step 308, archival module 150 applies purge rules 160 to the user input to determine code for execution. In an embodiment, the code may provide instructions to source module 110 or destination module 130 to purge data. In an embodiment, the code may instruct source module 110 or destination module 130 to communicate data to archival module 150 via network 104 for purging. In an embodiment, the code may identify data according to metadata. At step 310, archival module 150 receives data to be purged. For example, source module 110 may communicate source data 118 to archival module 150. In another example, destination module 130 may communicate destination data 138 to archival module 150 via network 104 for purging. The method may then proceed to step 312 where archival module 150 executes the generated code to purge the data. Archival module 150 may purge the data received from source module 110 and/or destination module 130. In an embodiment, the command to purge may be communicated directly to source module 110 or destination module 130. At step 314, the data identified in the user request is purged. In an embodiment, source module 110 purges source data 118. In an embodiment, destination module 130 purges destination data 138. In an embodiment archival module 150 purges intermediate data 162, where intermediate data 162 may be received from source module 110 and/or destination module 130. The method then proceeds to step 316 where archival module 150 determines if there is an additional user request. If there is an additional user request, the method proceeds back to step 302. Otherwise, the method proceeds to step 332 and ends.

If the user input does not comprise a request to purge data in step 304, the method proceeds to step 318 where archival module 150 determines whether the user input comprises a request to archive data. If the user input does not comprise a request to archive data, the method proceeds to step 332 where it ends. However, if the user input does comprise a request to archive data, the method proceeds to step 320 where archival module 150 retrieves archive rules 158. At step 322, archival module 150 applies archive rules 158 to the user input to determine code for execution. For example, the code may identify data to be archived and instructions to archive the data. In an embodiment, data may be identified according to metadata. At step 324, archival module 150 retrieves the identified data. In an embodiment, archival module 150 may only retrieve a copy of the data. In an embodiment, the code may instruct source module 110 to communicate identified source data 118 to archival module 150 via network 104. In another embodiment, the code may instruct source module 110 to communicate the identified source data 118 to destination module 130 via network 104 for archival. In the embodiment where archival module 150 receives the data, archival module 150 may store the data in memory 156 as intermediate data 162. In certain embodiments, archival module 150 may transform the received data into a format suitable for destination module 130. At step 326, the code is executed to communicate a command to archive data. For example, the command may instruct archival module 150 or source module 110 to communicate the identified data to destination module 130. The code may also instruct destination module 130 how and where to store the received data. At step 328, the data identified in the user request is archived according to the user request. The method then proceeds to step 330 where archival module 150 determines whether the user request comprises an additional request. If there is an additional user request, the method proceeds back to step 302 and continues as discussed. Otherwise, the method proceeds to step 330 where it ends.

Modifications, additions, or omissions may be made to the method depicted in FIG. 3. The method may include more, fewer, or other steps. For example, archival module 150 may not receive data, but may communicate a request to source module 110 and/or destination module 130 to archive or purge data. As another example, when system 100 archives data, the system may instruct destination module 130 or any other suitable component of system 100 to purge the data after a predetermined time. As yet another example, steps may be performed in parallel or in any suitable order. While discussed as archiving module 150 performing the steps, any suitable component of system 100 may perform one or more steps of the method.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
an interface operable to receive a user request associated with a first set of data; and
a processor operable to:
determine whether the user request comprises a request to archive the first set of data; and
upon a determination that the user request comprises a request to archive the first set of data:
facilitate retrieving archive rules;
apply the archive rules to determine a first archive code for execution; and
archive the first set of data based on the first archive code.

2. The system of claim 1, further comprising:
the processor further operable to:
determine whether the user request comprises a request to purge the first set of data; and
upon a determination that the user request comprises a request to purge the first set of data:
facilitate retrieving purge rules;
apply the purge rules to determine a purge code for execution; and
purge the first set of data based on the purge code.

3. The system of claim 1, wherein the archive code identifies the first set of data by metadata.

4. The system of claim 1, further comprising:
the interface further operable to retrieve purge rules; and
the processor further operable to:
apply the purge rules to determine a purge code for execution; and
purge the archived data based on the purge code, the archived data purged after a predetermined time.

5. The system of claim 1, wherein the first set of data comprises information related to a call received by a call center.

6. The system of claim 1, further comprising:
the interface further operable to receive a second user request associated with a second set of data; and
the processor further operable to:
determine whether the user request comprises a request to archive the second set of data, the second set of data different than the first set of data;
upon a determination that the user request comprises a request to archive the third set of data;
facilitate retrieving the archive rules;
apply the archive rules to determine a second archive code for execution, the second archive code different than the first archive code; and
archive the second set of data based on the second archive code.

7. The system of claim 1, wherein the data is converted to a different format before it is archived.

8. A method, comprising:
receiving a user request associated with a first set of data;
determining whether the user request comprises a request to archive the first set of data; and
upon a determination that the user request comprises a request to archive the first set of data:
retrieving archive rules;
applying the archive rules to determine a first archive code for execution; and
archiving the first set of data based on the first archive code.

9. The method of claim 8, further comprising:
determining whether the user request comprises a request to purge the first set of data; and
upon a determination that the user request comprises a request to purge the first set of data:
retrieving purge rules;
applying the purge rules to determine a purge code for execution; and
purging the first set of data based on the purge code.

10. The method of claim 8, wherein the archive code identifies the first set of data by metadata.

11. The method of claim 8, further comprising:
retrieving purge rules;
applying the purge rules to determine a purge code for execution; and
purging the archived data based on the purge code, the archived data purged after a predetermined time.

12. The method of claim 8, wherein the first set of data comprises information related to a call received by a call center.

13. The method of claim 8, further comprising:
receiving a second user request associated with a second set of data;
determining whether the user request comprises a request to archive the second set of data, the second set of data different than the first set of data;
upon a determination that the user request comprises a request to archive the third set of data;
retrieving the archive rules;
applying the archive rules to determine a second archive code for execution, the second archive code different than the first archive code; and
archiving the second set of data based on the second archive code.

14. The method of claim 8, wherein the data is converted to a different format before it is archived.

15. Non-transitory computer readable medium comprising logic, the logic, when executed by a processor, operable to:
receive a user request associated with a first set of data;
determine whether the user request comprises a request to archive the first set of data; and
upon a determination that the user request comprises a request to archive the first set of data:
retrieve archive rules;
apply the archive rules to determine a first archive code for execution; and
archive the first set of data based on the first archive code.

16. The computer readable medium of claim 15, wherein the logic is further operable to:
determine whether the user request comprises a request to purge the first set of data; and
upon a determination that the user request comprises a request to purge the first set of data:
retrieve purge rules;
apply the purge rules to determine a purge code for execution; and
purge the first set of data based on the purge code.

17. The computer readable medium of claim 15, wherein the archive code identifies the first set of data by metadata.

18. The computer readable medium of claim 15, wherein the logic is further operable to:
retrieve purge rules;
apply the purge rules to determine a purge code for execution; and
purge the archived data based on the purge code, the archived data purged after a predetermined time.

19. The computer readable medium of claim 15, wherein the first set of data comprises information related to a call received by a call center.

20. The computer readable medium of claim 15, wherein the data is converted to a different format before it is archived.
